(19) United States
(12) Patent Application Publication
(10) Pub. No.: US 2007/0095475 A1
(43) Pub. Date: May 3, 2007

(54) ADHESIVE MATERIAL AND METHOD OF USING SAME

(75) Inventors: Christopher Hable, Romeo, MI (US); Brandon Madaus, Shelby Twp., MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 11/552,331

(22) Filed: Oct. 24, 2006

Related U.S. Application Data
(60) Provisional application No. 60/732,291, filed on Nov. 1, 2005.

(51) Int. Cl. C09J 163/00

(52) U.S. Cl. 156/330

(57) ABSTRACT

An adhesive and/or activatable (e.g., heat expandable and/or curable) material and articles incorporating the same are disclosed. The material includes an epoxy resin, an epoxy/elastomer hybrid or reaction product or both; a blowing agent, a curing agent or both; and optionally, a filler.

### CLAIM OF PRIORITY

This application claims the benefit of the filing date of U.S. Provisional Application No. 60/732,291 filed Nov. 1, 2005.

### FIELD OF THE INVENTION

The present invention relates generally to an adhesive material and a method of forming and applying the same.

### BACKGROUND OF THE INVENTION

For many years, industry has been concerned with designing materials such as adhesives, structural materials or combinations thereof. As examples, the transportation industry and, particularly, the aerospace industry has been concerned with designing adhesive structural materials that do not add significantly to the weight of airplanes, exhibit adhesive strength, have high strength to weight ratios or the like. Conventional structural adhesive materials can suffer from multiple different drawbacks. For example, many conventional materials exhibit relatively poor adhesion to substrates that have not undergone surface preparations such as cleaning, roughening or other treatment. Other conventional materials exhibit relatively poor shelf lives, can be difficult to handle and can also exhibit relatively poor dimensional stability. Moreover, expandable (e.g., foamable) adhesive materials often exhibit too much or too little expansion for particular applications. As such, there is a need for a structural adhesive material that overcomes one or more of the aforementioned drawbacks.

### SUMMARY OF THE INVENTION

An adhesive material and a method of attaching members with the adhesive material are disclosed. The adhesive material typically includes epoxy resin, epoxy/elastomer adduct and curing agent. The adhesive material can include any combination of the following ingredients and/or characteristics: 1) blowing agent; 2) the adhesive material can substantially devoid of thermoplastic polymers; 3) reinforcement material such as aramid pulp; 4) nanoclay; 5) the epoxy/elastomer adduct can include an epoxy-carboxyl terminated butyl nitrile rubber adduct; 6) the epoxy/elastomer adduct can include both liquid and solid adduct.

According the method of adhesion, a first member and a second member are provided wherein both the first member and the second member are preferably components of a wing or fuselage of an airplane such as a frame, a stringer, a skin and a spar. The adhesive material is contacted with a surface of the first member and a surface of the second member such that the adhesive material whets and adheres to the first member and the second member. In one preferred embodiment, the contacting of the adhesive material with the surface of the first member and the surface of the second member includes activating the adhesive material to foam and thermoset and the adhesive material whets and adheres to the first member and second member during foaming and thermosetting.

### BRIEF DESCRIPTION OF THE DRAWINGS

The features and inventive aspects of the present invention will become more apparent upon reading the following detailed description, claims and drawings, of which the following is a brief description:

FIG. 1 illustrates a first member adhered to a second member with the adhesive material of the present invention;

FIG. 2 illustrates a cut-away perspective view of an exemplary wing of an airplane according to one aspect of the present invention.

FIG. 3 is a side sectional view of the exemplary wing of FIG. 2.

FIG. 4 illustrates an exemplary portion of a fuselage of an airplane according to another aspect of the present invention.

### DETAILED DESCRIPTION OF THE INVENTION

The present invention is predicated upon providing an improved adhesive material, a method of using the adhesive materials and articles incorporating the adhesive material. The adhesive material is preferably activatable such that it expands (e.g., foams), cures (e.g., cross-links or thermosets) or both upon exposure to a condition such as heat, moisture, radiation, combinations thereof or the like. While the adhesive material is typically expandable upon activation, it is contemplated that certain embodiments of the material may be substantially non-expansive.

Typically, in additional to adhesion, the adhesive material assists in providing structural reinforcement, sealing, acoustical damping properties or a combination thereof to and/or between members to which the adhesive material is adhered. The adhesive material of the present invention may be applied to various articles of manufacture for adding structural integrity to portions or members of articles, for providing acoustical damping to the articles or for sealing the articles. Examples of such articles of manufacture include, without limitation, household or industrial appliances, furniture, storage containers, buildings, structures or the like. In preferred embodiments, the adhesive material is applied to portions of a transportation vehicle. It has been found that the adhesive material is particularly useful for adhering to members of airplanes or other aerospace vehicles.

The adhesive material preferably includes:

(a) 1 to about 80 parts by weight of an epoxy resin;

(b) 1 to about 70 parts by weight of an elastomer-containing adduct;

(c) 0.01 to about 10 parts by weight of a blowing agent;

(d) 0.1 to about 10 parts by weight of a curing agent; and

(e) optionally, a filler.

One method of the present invention contemplates applying the adhesive material to a surface of one or more members in an unexpanded or partially expanded state and activating the material for expanding it to a volume that is at least 105%, at least 120%, at least 170%, 300%, 500% or more of the volume of the adhesive material prior to expansion thereof. While the adhesive material typically is employed to a surface of a first member and a surface of a second member where the first member is separate from the second member, it is contemplated that the adhesive material may be adhered to a first surface or portion and a second surface or portion of a single member.

Percentages herein refer to weight percent, unless otherwise indicated.

Epoxy Resin

Epoxy resin is used herein to mean any of the conventional dimeric, oligomeric or polymeric epoxy materials containing at least one epoxy functional group. The polymer-based materials may be epoxy containing materials having one or more oxirane rings polymerizable by a ring opening reaction. In preferred embodiments, the structural adhesive material includes up to about 80% of an epoxy resin. More preferably, the adhesive includes between about 10% and 70% by weight epoxy resin and still more preferably between about 30% and 50% by weight epoxy resin.

The epoxy may be aliphatic, cycloaliphatic, aromatic or the like. The epoxy may be supplied as a solid (e.g., as pellets, chunks, pieces or the like), a liquid (e.g., an epoxy resin that is liquid at 23° C. or a combination thereof). One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with butadiene or another polymeric additive.

In preferred embodiments, one or more of the epoxy resins employed in the adhesive material are multifunctional and/or have relatively high functionalities (e.g., epoxy functionalities). When such relatively high functionality resins are employed, it is typically desirable for at least 5%, more typically at least 10% and even possibly at least 15% or even at least 20% of the epoxy resins have a functionality that is greater than about 2 (e.g., about 2.6 or greater), more typically greater than about 3 (e.g., about 3.6 or greater) and still more typically greater than about 4.5 (e.g., about 5.1 or greater). Advantageously, such higher functionality can, in certain instances, provide for improved high temperature performance, improved lap shear strength or a combination thereof. However, in other circumstances (e.g., where lower Tg is desired) lower amounts of higher functionality resin and/or lower functionality resins can be desirable.

Elastomer-Containing Adduct

In a highly preferred embodiment, an elastomer-containing adduct is employed in the adhesive material of the present invention, and preferably in a relatively high concentration (e.g., on the order of the epoxy resin). The epoxy/elastomer hybrid or reaction product may be included in an amount of up to about 80% by weight of the adhesive material. More preferably, the elastomer-containing adduct is approximately 20 to 60%, and more preferably is about 35% to 55% by weight of the adhesive material. Of course, the elastomer-containing adduct may be a combination of two or more particular adducts and the adducts may be solid adducts or liquid adducts at a temperature of 23° C. or may also be combinations thereof.

The adduct itself generally includes about 1:5 to 5:1 parts of epoxy to elastomer, and more preferably about 1:3 to 3:1 parts or epoxy to elastomer. More typically, the adduct includes at least about 5%, more typically at least about 12% and even more typically at least about 18% by weight elastomer and also typically includes not greater than about 50%, even more typically no greater than about 40% and still more typically no greater than about 30% elastomer by weight, although higher or lower percentages are possible. These stated percentages of elastomer are typical for solid adducts, however, certain liquid adducts can include at least 35% or even at least 45% by weight elastomer.

The elastomer compound may be any suitable art disclosed elastomer such as a thermosetting elastomer. Exemplary elastomers include, without limitation natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. In one embodiment, recycled tire rubber is employed. Examples of additional or alternative epoxy/elastomer or other adducts suitable for use in the present invention are disclosed in U.S. Patent Publication 2004/0204551, which is incorporated herein by reference for all purposes.

The elastomer-containing adduct, when added to the adhesive material, preferably is added to modify structural properties of the adhesive material such as strength, toughness, stiffness, flexural modulus, or the like. Additionally, the elastomer-containing adduct may be selected to render the adhesive material more compatible with coatings such as water-borne paint or primer system or other conventional coatings.

According to one preferred embodiment, the adhesive material includes a portion of a liquid adduct (i.e., liquid at a temperature of about 23° C.) and a portion of one or more solid adducts (i.e., solid at a temperature of about 23° C.) for assisting in improving properties such as impact strength, peel strength, combinations thereof or others. Thus, in one embodiment, it is contemplated that for all adducts in the adhesive material, at least about 15%, more typically at least about 25% and even more typically at least about 40% by weight of the adducts are liquid and at least about 15%, more typically at least about 25% and even more typically at least about 40% by weight of the adducts are solid. In other embodiments, the ratio of solid adduct to liquid adduct is between about 8 to 1 and 1 to 1, more typically between about 5 to 1 and about 1.5 to 1 and still more typically between about 4 to 1 and about 2 to 1 (e.g., about 3 to 1) when measured by weight.

Blowing Agent

One or more blowing agents may be added to the adhesive material. The blowing agents may be chemical and produce inert gasses that form, as desired, an open and/or closed cellular structure within the adhesive material or may be physical and either may be activated upon exposure to a condition such as heat, radiation, moisture, chemical reaction, combinations thereof or the like. In this manner, it may be possible to lower the density of articles fabricated from the material. In addition, the material expansion helps to improve sealing capability, substrate wetting ability, adhesion to a substrate, acoustic damping, combinations thereof or the like.

The blowing agent may include one or more nitrogen containing groups such as amides, amines and the like. Examples of suitable blowing agents include azodicarbonamide, dinitrosopentamethylenetetramine, 4,4ᵢ-oxy-bis-(benzenesulphonylhydrazide), trihydrazinotriazine and N, Nᵢ-dimethyl-N,Nᵢ-dinitrosoterephthalamide. Other potential blowing agents include solvent encapsulated in thermoplastic shells.

An accelerator for the blowing agents may also be provided in the adhesive material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles, hydrazides, imidazoles, ureas, combinations thereof or the like.

Amounts of blowing agents and blowing agent accelerators can vary widely within the adhesive material depending upon the type of cellular structure desired, the desired amount of expansion (e.g., foaming) of the adhesive material, the desired rate of expansion, desired cure conditions and the like. Exemplary ranges for the amounts of blowing agents and blowing agent accelerators in the adhesive material range from about 0.001% by weight to about 5% by weight and are preferably in the adhesive material in fractions of weight percentages.

In one embodiment, the present invention contemplates the omission of a blowing agent. Thus it is possible that the material will not be an adhesive material. Preferably, the formulation of the present invention is thermally activated. However, other agents may be employed for realizing activation by other means, such as moisture, radiation, or otherwise.

Curing Agent

One or more curing agents and/or curing agent accelerators may be added to the adhesive material. Amounts of curing agents and curing agent accelerators can, like the blowing agents, vary widely within the adhesive material depending upon the type of cellular structure desired, the desired amount of expansion of the adhesive material, the desired rate of expansion, the desired structural properties of the adhesive material, the desired cure conditions (e.g., manufacturing conditions) and the like. Exemplary ranges for the curing agents or curing agent accelerators present in the adhesive material range from about 0.01% by weight to about 7% by weight.

Preferably, the curing agents assist the adhesive material in curing by crosslinking of the epoxy containing adducts, epoxy resins (e.g., by reacting in stoichiometrically excess amounts of curing agent with the epoxide groups on the resins), other polymers or a combination thereof. It is also preferable for the curing agents to assist in thermosetting the adhesive material. Useful classes of curing agents are materials selected from aliphatic or aromatic amines or their respective adducts, amidoamines, polyamides, cycloaliphatic amines, (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, hydrazides (e.g., dihydrazide), sulphones (e.g., diamino diphenyl sulphone (DDS)), dicyandiamides and the like. An accelerator for the curing agents (e.g., a modified or unmodified urea such as methylene diphenyl bis urea, an imidazole or a combination thereof) may also be provided for preparing the adhesive material.

Desirable cure times can vary depending upon manufacturing processes and other factors. Moreover, such curing times can depend upon whether additional energy (e.g., heat, light, radiation) is applied to the material or whether the material is cured at room temperature.

Filler

The adhesive material may also include one or more fillers, including but not limited to particulated materials (e.g., powder), beads, microspheres, or the like. Preferably the filler includes a relatively low-density material that is generally non-reactive with the other components present in the adhesive material.

Examples of fillers include silica, diatomaceous earth, glass, clay, talc, pigments, colorants, glass beads or bubbles, glass, carbon ceramic fibers, antioxidants, and the like. Such fillers, particularly clays, can assist the adhesive material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, wollastonite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate, magnesium carbonate or the like may be used as fillers. In another preferred embodiment, silicate minerals such as mica may be used as fillers. It has been found that, in addition to performing the normal functions of a filler, silicate minerals and mica in particular improved the impact resistance of the cured adhesive material.

When employed, the fillers in the adhesive material can range from 2% to 90% by weight of the adhesive material. According to some embodiments, the adhesive material may include from about 0.001% to about 30% by weight, and more preferably about 10% to about 20% or about 3 to about 10% by weight clays or similar fillers. Powdered (e.g. about 0.01 to about 50, and more preferably about 1 to 25 micron mean particle diameter) mineral type filler or other fillers can comprise between about 1% and 70% by weight, more preferably about 3% to about 20%, and still more preferably approximately 6% by weight of the adhesive material.

It is contemplated that one of the fillers or other components of the material may be thixotropic for assisting in controlling flow of the material as well as properties such as tensile, compressive or shear strength.

Other Additives

Other additives, agents or performance modifiers may also be included in the adhesive material as desired, including but not limited to a UV resistant agent, a flame retardant, an impact modifier, a heat stabilizer, a UV photoinitiator, a colorant, a processing aid, a lubricant, a reinforcement (e.g., chopped or continuous glass, ceramic, aramid (e.g., aramid pulp), or carbon fiber or the like).

When determining appropriate components for the adhesive material, it may be important to form the material such that it will only activate (e.g., flow, foam, cure or otherwise change states) at appropriate times or temperatures. For instance, in most applications, it is undesirable for the material to be reactive at room temperature or otherwise at the ambient temperature in a production environment. More typically, the adhesive material becomes activated to flow at higher processing temperatures. As an example, temperatures such as those encountered during airplane manufacture may be appropriate, especially when the adhesive material is processed along with the other components of an airplane at elevated temperatures or at higher applied energy levels, e.g., during curing of matrix materials (e.g., cure of skins of airplanes in an autoclave or oven). Temperatures encountered during such airplane manufacture are typically at least about 150° F., more typically at least about 185° F. and even more typically about 220° F. and are also typically below about 320° F., more typically below about 285° F. and even more typically below about 250° F. Moreover, exposure times to such temperatures are typically at least about 10 minutes, more typically at least about 40 minutes and still more typically at least about 60 minutes and are also typically below about 240 minutes, more typically below about 190 minutes and still more typically below about 120 minutes.

Highly Preferred Embodiments and Examples

It is contemplated within the present invention that polymers other than those discussed above such as thermoplastics may also be incorporated into the adhesive material, e.g., by copolymerization, by blending, or otherwise. For example, without limitation, other polymers that might be appropriately incorporated into the adhesive material include halogenated polymers, polycarbonates, polyketones, urethanes, polyesters, silanes, sulfones, allyls, olefins, styrenes, acrylates, methacrylates, epoxies, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

In certain particular embodiments, however, the adhesive material is substantially devoid of thermoplastic polymers or thermoplastic polymer blends, which can increase glass transition temperatures of the material. Particularly, certain embodiments of the adhesive material are devoid of thermoplastic polymers such as acetates (e.g., EVA) and acrylates (e.g., EMA). In such embodiments, the adhesive material is preferably composed of greater than about 30 or 40% by weight of epoxy resin such as Bis-phenol A liquid epoxy and or other resins, greater than about 30 or 40% by weight of epoxy/elastomer adduct such as solid epoxy-carboxyl terminated butyl nitrile (CTBN) rubber adduct or other adducts and also typically includes a fiber such as a pulped form of aramid fiber and or a filler such as calcined clay. Such embodiments are particularly advantageous because the aramid fiber in combination with the epoxy-elastomer component of the adhesive material and the other components allows for the formation of a tacky product with good physical integrity without the use of certain thermoplastic polymers (e.g., EVA or EMA), which can tend to exhibit poor compatibility in an epoxy based system and can reduce strength and adhesion durability. Of course, it is contemplated that the adhesive material may also be formulated to have low or substantially no tack at about 23° C., particularly by including solid and/or higher molecular weight epoxy resins and or adducts.

Additionally, in preferred embodiments, a nanoclay additive may be used for added control of flow properties, physical properties, adhesion durability, hydrolysis resistance, combinations thereof or the like. Nanoclay may be include from about 0.1% to about 4% by weight of the adhesive material, more preferably from about 0.5% to about 2% by weight, and even more preferably about 1% by weight of the adhesive material.

### EXAMPLES

Tables A, B and C of exemplary adhesive materials are provided below. The tables list a description of ingredients and weight percentages of the ingredients.

TABLE A

| Description | A | B |
|---|---|---|
| Solid epoxy-solid rubber adduct | 38.54 | 38.64 |
| Liquid epoxy-liquid rubber adduct | 13.13 | 13.16 |
| Liquid Epoxy | 15.95 | 15.99 |
| Epoxy Phenol Novalac | 15.95 | 15.99 |
| (Multifunctional Liquid Epoxy) (functionality | | |
| greater than 3) | | |
| Epoxy Phenol Novalac | | |
| (Multifunctional Liquid Epoxy) (functionality | | |
| greater than 2) | | |
| Epoxy Cresol Novalac (Multifunctional Solid | 5.32 | 5.33 |
| Epoxy) (functionality greater than 5) | | |
| Calcined Clay | 5.25 | 5.28 |
| Dicyandiamide | 4.51 | 4.52 |
| Modified Urea | 0.95 | 0.95 |
| Imidazole Complex | | |
| Hydrazide | | |
| Accelerated Blowing Agent | 0.30 | 0.05 |
| pigment | 0.11 | 0.11 |

TABLE B

| Description | A | B |
|---|---|---|
| Solid epoxy-solid rubber adduct | 37.89 | 38.02 |
| Liquid epoxy-liquid rubber adduct | 12.91 | 12.95 |
| Liquid Epoxy | 15.68 | 15.73 |
| Epoxy Phenol Novalac | | |
| (Multifunctional Liquid Epoxy) (functionality greater than | | |
| 3) | | |
| Epoxy Phenol Novalac | 15.68 | 15.73 |
| (Multifunctional Liquid Epoxy) (functionality greater than | | |
| 2) | | |
| Epoxy Cresol Novalac (Multifunctional Solid Epoxy) | 5.23 | 5.24 |
| (functionality greater than 5) | | |
| Calcined Clay | 5.17 | 5.19 |
| Dicyandiamide | 4.43 | 4.45 |
| Modified Urea | 0.93 | 0.94 |
| Imidazole Complex | 0.60 | 0.60 |
| Hydrazide | 0.99 | 0.99 |
| Accelerated Blowing Agent | | |
| Hydrazide Blowing Agent | 0.39 | 0.05 |
| pigment | 0.10 | 0.10 |

TABLE C

| Description | #1 | #2 |
|---|---|---|
| Solid epoxy liquid rubber adduct | 36.25% | 36.25% |
| Liquid Epoxy | 41.11% | 41.11% |
| Solid Epoxy | 2.00% | 2.00% |
| Calcined Clay | 12.67% | 12.94% |
| Aramid Pulp | 2.3% | 2.30% |
| Dicyandiamide | 1.75% | 1.75% |
| Dicyandiamide | 1.75% | 1.75% |
| Mixed mineral filler (Nanoclay) | 1.01% | 1.01% |
| Modified Urea | 0.79% | 0.79% |
| Blowing Agent | 0.27% | |
| pigment | 0.10% | 0.10% |

The above formulations of the adhesive material are provided as examples. Since they are merely exemplary, it is contemplated that the weight percents of the various ingredients may vary by ±50% or more or by ±30% or ±10%. For example, a value of 50±10% is a range of 45 to 55. Moreover, ingredients may be added or removed from the formulations.

Formation and Application of the Adhesive Material

Formation of the adhesive material can be accomplished according to a variety of new or known techniques. Preferably, the adhesive material is formed as a material of substantially homogeneous composition. However, it is contemplated that various combining techniques may be used to increase or decrease the concentration of certain components in certain locations of the adhesive material.

According to one embodiment, the adhesvie material is formed by supplying the components of the material in solid form such as pellets, chunks, powders and the like, in liquid form or a combination thereof. The components are typically combined in one or more containers such as large bins or other containers. Preferably, the containers can be used to intermix the components by rotating or otherwise moving the container. Thereafter, heat, pressure or a combination thereof may be applied to soften or liquidize the components such that the components can be intermixed by stirring or otherwise into a single homogenous composition.

According to another embodiment, the adhesive material may be formed by heating one or more of the components that is generally easier to soften or liquidize such as the polymer based materials to induce those components into a mixable state. Thereafter, the remaining components may then be intermixed with the softened components.

Depending upon the components used, it may be important to assure that the temperature of the components remains below certain activation temperatures that might cause the adhesive material to activate (e.g., form gasses, foam, flow, cure (e.g., harden, stiffen or otherwise change states) or otherwise activate). Notably, when the adhesive material contains a blowing agent, it is typically desirable to maintain the temperature of the adhesive material below a temperature that will activate the blowing agent during formation of the adhesive material or before the adhesive material is applied to a surface.

In situations where it is desirable to maintain the adhesive material at lower temperatures it may be desirable to maintain the components in a semi-solid or viscoelastic state using pressure or a combination of pressure and heat to intermix the components of the adhesive material. Various machines have been designed to apply heat, pressure or both to materials. One preferred machine is an extruder. According to one embodiment of the present invention, various components may be premixed into one, two or more pre-mixtures and introduced at one or various locations in a single or twin-screw extruder. Thereafter, the heat and pressure provided by the extruder mixes the adhesive material in a single generally homogeneous composition, and preferably does so without activating the material.

Activation of the material may include at least some degree of foaming or bubbling in situations where the adhesive material includes a blowing agent. Such foaming or bubbling can assist the adhesive material in wetting a surface or substrate and forming an intimate bond with the substrate. Alternatively, however, it shall be recognized that the adhesive material may be activated to flow without foaming or bubbling and may still substantially wet the substrate to form an intimate bond. Formation of the intimate bond will typically but not necessarily occur upon curing of the adhesive material.

Advantageously, the adhesive material of the present invention has shown valuable properties. Upon testing, valuable properties were exhibited for expansion, for lap shear and fatigue resistance. The following lap shear strengths are determinable according to ASTM D1002-01. Lap shear strength of the adhesive material at 73.4° F. is often greater than about 2000 psi, often greater than about 3000 psi, can be greater than 4000 psi and can even be greater than about 4500 psi. Lap shear strength of the adhesive material at −67° F. is often greater than about 2000 psi, often greater than about 2300 psi, can be greater than 2800 psi and can even be greater than about 3300 psi. Lap shear strength of the adhesive material at 176° F. is often greater than about 1500 psi, often greater than about 1800 psi, can be greater than 2200 psi and can even be greater than about 3000 psi. Lap shear strength of the adhesive material at 73.4° F. after soak for about 7 days in airplane fuel is often greater than about 2000 psi, often greater than about 2800 psi, can be greater than 3700 psi and can even be greater than about 4300 psi. Of course such properties are not required unless otherwise stated.

In another embodiment of the present invention, an outer surface of the material of the present invention is treated for allowing it to be handled without undesirable material transfer, such as to a vehicle body surface. Thus, it is possible that the formulation may be provided with a temporary layer (from less than about 10 microns to about 2 cm (e.g., on the order of less than about 1 mm)) that is generally free of tack for facilitating handling. This may take the form of a polymer transfer film, a water based coating, a powder coating or otherwise, which may be curable (e.g., thermosetting) for becoming part of the adhesive material. Examples of such films and coatings are disclosed in U.S. Pat. No. 6,811,864 and U.S. Patent Application publication number 2004/0076831, both of which are incorporated herein by reference for all purposes. The adhesive material may also be provided with a release layer (e.g., a paper or plastic release film) that can be used for handling the material and can be removed prior to or during application of the adhesive material. The present invention thus also contemplates a tacky structural adhesive material having a handling surface that is generally free of tack to the touch.

Other applications for which the present technology may be adapted or employed as an adhesive material include those of the type identified in U.S. Pat. Nos. 6,358,584; 6,311,452; 6,296,298, all of which are hereby incorporated by reference. The material of the present invention may thus be applied to a carrier, such as a molded, extruded or stamped member (e.g., metal or plastic, foamed or unfoamed; exemplary materials of which include aluminum, magnesium, titanium, steel, polyamide (e.g., nylon 6 or nylon 6,6), polysulfone, thermoplastic imide, polyether imide, polyether sulfone or mixtures thereof. Typically, the adhesive material is applied to or contacted with one or more members of an article of manufacture directly.

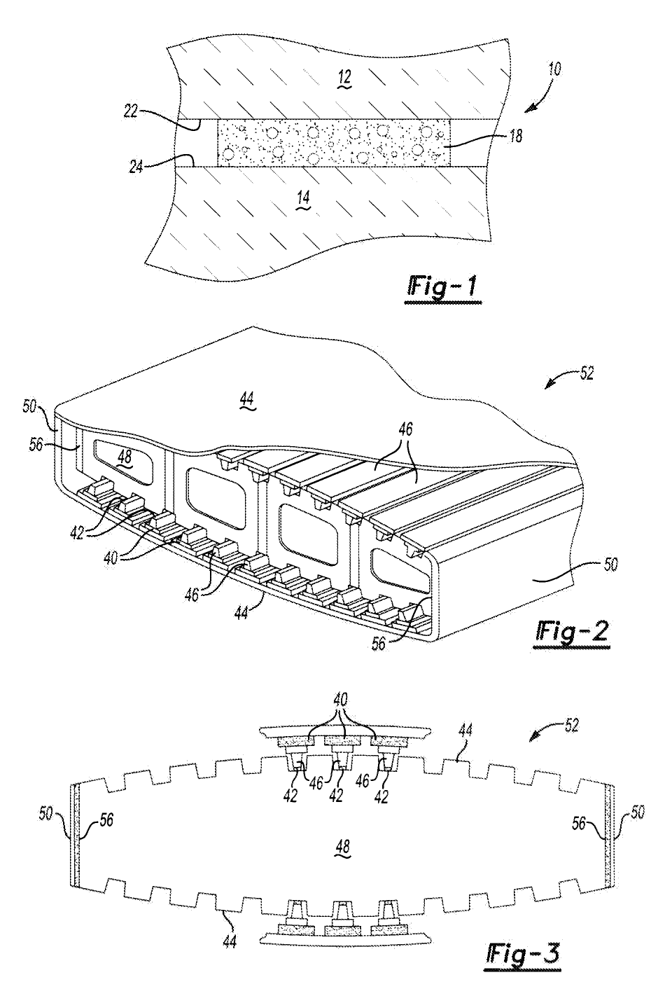

Referring to FIG. 1, there is illustrated an exemplary embodiment of a joint 10 between a first member 12 and a second member 14. As can be seen, an amount of adhesive material 18 of the present invention has been positioned between and/or contacted with a surface 22 of the first member 12 and a surface 24 of the second member 14. Upon activation, the adhesive material 18 preferably expands (e.g., foams) whets and adheres to the surfaces 22, 24 of the members 12, 14. Simultaneously or thereafter, the adhesive material 18 is preferably cured (e.g., crosslinked or thermoset) to form a structural foam and/or activated material that adheres to the members 12, 14 and provides attachment, sealing, baffling, reinforcement or the like to the members 12, 14 and/or the joint 10. Advantageously, expansion of the adhesive material can assist in filling imperfections or gaps that may be present in substrate to be bonded together, although it is not necessarily required. The discussion of attachment or adhesion of members 12, 14 refers to members generally, however, such discussion is applicable to the attachment or adhesion of more specific members as discussed below in reference to FIGS. 2-4 and in reference to other members or components, which may not be shown.

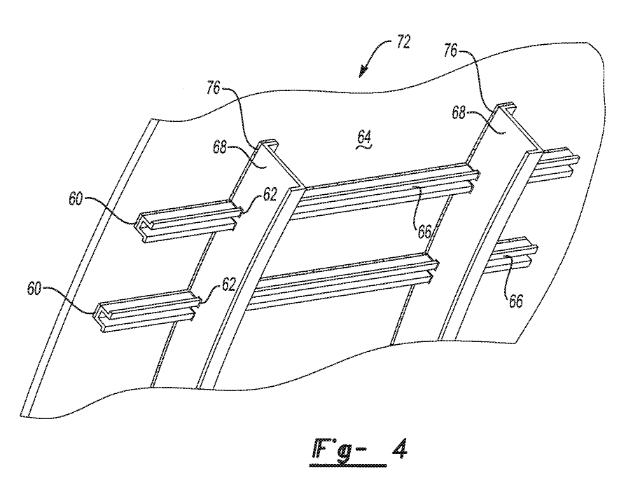

Referring to FIG. 2 and 3, first masses 40 and second masses 42 of the adhesive material have been applied (e.g., located between, contacted with or both) and activated to expand and/or adhere to members 44, 46, 48, 50 of a wing or rudder 52 of an airplane or other control components of an airplane such as those mentioned below. As can be seen, the first masses 40 have been applied to and activated to expand and/or adhere to skins 44 and stringers 46 of the wing or rudder 52 and the second masses have been applied to and activated to expand and/or adhere to the stringers 46 and the rib 48 of the wing or rudder 52. Also shown, third masses 56 have been applied to and activated to expand and/or adhere to the spars 50 and the rib 48. In addition to the above, it is contemplated that the adhesive material of the present invention may be applied to and activated to expand and/or adhere the skins directly to one or more ribs and/or one or more spars. It is also contemplated that the adhesive material of the present invention could be applied to and activated to adhere the spars to the stringers.

Referring to FIG. 4, first masses 60 and second masses 62 of the adhesive material have been applied (e.g., located between, contacted with or both) and activated to expand and/or adhere to members 64, 66, 68 of a fuselage 72 of an airplane. As can be seen, the first masses 60 have been applied to and activated to expand and/or adhere to a skin 64 and stringers 66 of the fuselage 72 and the second masses have been applied to and activated to expand and/or adhere to the stringers 66 and the frames 68 of the fuselage 72. Also shown, third masses 76 have been applied to and activated to expand and/or adhere to the skin 64 and the frames 68.

It is further contemplated that the adhesive material of the present invention is quite suitable for application to other members of an airplane. As examples, the adhesive material can be applied to and activated to expand and/or adhere to one, two or more members, internally or otherwise, of a control component such as an aileron, an elevator, a rudder, tail section, combinations thereof or the like. As further examples and without limitation, the adhesive material can be applied to and activated to expand and/or adhere to one, two or more members, internally or otherwise, of a door assembly (e.g., to adhere panels to each other or to internal members of a door), a floor assembly or the like.

The components to which the adhesive material is applied and adhered to above can be made of a variety of materials. It has been found, however, that the adhesive material is particularly adept at adhering to metals (e.g., aluminum, steel (e.g., galvanized steel), magnesium, titanium, combinations thereof or the like) and composite materials (e.g., fibers such as carbon or glass fibers in a composite with polymeric or matrix materials such as epoxy resins, sheet or bulk molding compounds, phenol formaldehyde acrylic matrix material, thermosetting resins, combinations thereof or the like). Components above that are often formed of composite material include, without limitation, skin of the fuselage, skins of wings, skins of the aileron, rudder or tail section. Components above that are often formed of metal include stringers, ribs, frames and the like.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A method of attaching members, comprising:
providing a first member and a second member, both the first member and the second member being components of a wing or fuselage of an airplane; and
contacting an adhesive material with a surface of the first member and a surface of the second member such that the adhesive material whets and adheres to the first member and the second member, wherein:
i. the adhesive material includes epoxy/elastomer adduct; and
ii. the adhesive material includes a curing agent.

2. A method as in claim 1 wherein the first and second members are independently selected from the following: a frame, a stringer, a skin and a spar.

3. A method as in claim 1 wherein the adhesive material is substantially devoid of thermoplastic polymers.

4. A method as in claim 2 wherein the adhesive material includes greater than about 30% by weight of the epoxy resin.

5. A method as in claim 2 wherein the adhesive material includes greater than about 40% by weight of the epoxy/elastomer adduct.

6. A method as in claim 1 wherein the adhesive material includes a blowing agent.

7. A method as in claim 1 wherein contacting the adhesive material with the surface of the first member and the surface of the second member includes activating the adhesive material to foam and thermoset and wherein the adhesive material whets and adheres to the first member and second member during foaming and thermosetting.

8. A method as in claim 1, wherein the epoxy/elastomer adduct includes an epoxy-carboxyl terminated butyl nitrile rubber adduct.

9. A method as in claim 1, further comprising about 0.1% to about 4.0% by weight nanoclay.

10. A method as in claim 1, wherein the adhesive material exhibits a lap shear strength greater than about 2000 psi.

11. A method as in any of claims 1 wherein the adhesive material includes:
i. a fiber reinforcement material, the fiber reinforcement material being a pulped aramid fiber; and
ii. filler material including nanoclay, calcined clay or both;
wherein the adhesive adhesive material is substantially devoid of polymers acetate and acrylate polymers.

12. A method as in any of claims 1 wherein a substantial portion of the epoxy/elastomer adduct is liquid and a substantial portion of the adduct is solid.

13. A method of attaching members, comprising:
providing a first member and a second member, both the first member and the second member being components of a wing or fuselage of an airplane; and
contacting an adhesive material with a surface of the first member and a surface of the second member such that the adhesive material whets and adheres to the first member and the second member, wherein:
i. the adhesive material includes epoxy/elastomer adduct and at least a portion of the epoxy/elastomer adduct is a solid epoxy/solid elastomer adduct;
ii. the adhesive material includes a blowing agent and a curing agent;
iii. the adhesive material includes greater than about 30% by weight epoxy resin;
iv. the adhesive material include a fiber reinforcement material and nanoclay.

14. A method as in claim 13 wherein the first and second members are independently selected from the following: a frame, a stringer, a skin and a spar.

15. A method as in claim 13 wherein the adhesive material is substantially devoid of thermoplastic polymers and the adhesive material includes greater than about 40% by weight of the epoxy/elastomer adduct.

16. A method as in claim 13 wherein contacting the adhesive material with the surface of the first member and the surface of the second member includes activating the adhesive material to foam and thermoset and wherein the adhesive material whets and adheres to the first member and second member during foaming and thermosetting and wherein the adhesive material is activated through exposure to elevated temperature.

17. A method as in claim 13 wherein the epoxy/elastomer adduct includes an epoxy-carboxyl terminated butyl nitrile rubber adduct and the adhesive material exhibits a lap shear greater than about 2000 psi.

18. A method of attaching members, comprising:
providing a first member and a second member, both the first member and the second member being components of a wing or fuselage of an airplane and wherein the first and second members are independently selected from the following: a frame, a stringer, a skin and a spar; and
contacting an adhesive material with a surface of the first member and a surface of the second member such that the adhesive material whets and adheres to the first member and the second member, wherein:
i. the adhesive material includes greater than about 40% by weight epoxy/elastomer adduct;
ii. the epoxy/elastomer adduct includes an epoxy-carboxyl terminated butyl nitrile rubber adduct;
iii. the epoxy/elastomer adduct includes both a liquid adduct and a solid adduct;
iv. the adhesive material includes a blowing agent and a curing agent;
v. the adhesive material includes greater than about 30% by weight epoxy resin and a portion of the epoxy resin has a functionality greater than 3;
v. the adhesive material includes fiber reinforcement material and the fiber reinforcement material includes aramid pulp;
vi. the adhesive material includes nanoclay;
vii. the adhesive material is substantially devoid of thermoplastic polymers;
wherein contacting the adhesive material with the surface of the first member and the surface of the second member includes activating the adhesive material to foam and thermoset and wherein the adhesive material whets and adheres to the first member and second member during foaming and thermosetting and wherein the adhesive material is activated through exposure to elevated temperature

19. A method as in claim 18 wherein the epoxy/elastomer adduct includes about 1:3 to 3:1 parts of epoxy to elastomer.

20. A method as in claim 18 further comprising about 0.1% to about 4.0% by weight nanoclay wherein the adhesive material exhibits a lap shear greater than about 2000 psi.
